(19) United States
(12) Patent Application Publication
(10) Pub. No.: US 2005/0228649 A1
(43) Pub. Date: Oct. 13, 2005

(54) Method and apparatus for classifying sound signals

(76) Inventors: Hadi Harb, Lyon (FR); Liming Chen, Lyon (FR)

Correspondence Address: DENNISON, SCHULTZ, DOUGHERTY & MACDONALD, 1727 KING STREET, SUITE 105, ALEXANDRIA, VA, 22314, US

(21) Appl. No.: 10/518,539

(22) PCT Filed: Jul. 8, 2003
(86) PCT No.: PCT/FR03/02116

§ 371 Date: Mar. 30, 2005

(30) Foreign Application Priority Data
Jul. 8, 2002 (FR) 02/08548

(51) Int. Cl. G10L 19/14

(52) U.S. Cl. 704/205; 704/211

(57) ABSTRACT

The invention concerns a method for assigning at least one sound class to a sound signal, characterized in that it comprises the following steps: dividing the sound signal into temporal segments having a specific duration, extracting the frequency parameters of the sound signal in each of the temporal segments, by determining a series of values of the frequency spectrum in a frequency range between a minimum frequency and a maximum frequency, assembling the parameters in time windows having a specific duration greater than the duration of the temporal segments, extracting from each time window, characteristic components, and on the basis of the extracted characteristic components and using a classifier, identifying the sound class of the time windows of the sound signal.

The invention concerns the field for classifying a sound signal into acoustic classes reflecting a semantic.

The invention more precisely concerns the field for automatically extracting a sound signal, semantic information such as music, speech, noise, silence, man, woman, rock music, jazz, etc.

In prior art, the profusion of multimedia documents requires an indexing requiring a large amount of human intervention, which constitutes a costly and long operation being successfully carried out. Consequently, the automatic extraction of semantic information constitutes a precious aid enabling analysis and indexing work to be facilitated and accelerated.

In numerous applications, the semantic segmentation and classification of a sound band frequently constitutes necessary operations prior to envisaging other analyses and treatments on the sound signal.

A known application requiring semantic segmentation and classification concerns automatic speech recognition systems also known as voice dictation systems suitable for transcribing a band of speech into text. Segmentation and classification of the sound band into music/speech segments are essential steps for an acceptable level of performance.

The use of an automatic speech recognition system for indexing via the contents of an audiovisual document, as for example, television news, requires non-speech segments to be eliminated in order to reduce the error rate. Furthermore, in principal if knowledge of the speaker (man or woman) is available, the use of an automatic speech recognition system enables a significant improvement of the performances to be achieved.

Another known application having recourse to the semantic segmentation and classification of a sound band concerns statistical and monitoring systems. Indeed, for questions of respecting copyright or respecting the broadcasting time quota, regulatory and inspection bodies like the CSA or the SACEM in France, must be based on specific reports, for example on the broadcasting time duration by politicians on television networks for the CSA and the title and duration of songs transmitted by radios for the SAGEM. The implementation of automatic statistical and monitoring systems is based in advance on segmentation and classification of a music/speech sound band.

Another possible application is related to an automatic audiovisual programme summary or filtering system. For numerous applications, as for example, mobile telephony or mail-order sales of audiovisual programmes, it seems necessary to possibly summarize, according to the centre of interest of a user, an audiovisual programme of two hours into a compilation of strong moments of a few minutes. Such a summary may be produced either off-line, that is it concerns a summary computed in advance which is associated to the original programme, or on-line, that is it concerns the filtering of an audiovisual programme enabling only the strong moments of a programme to be kept in broadcasting or streaming mode. The strong moments depend on the audiovisual programme and the centre of interest of the user. For example, in a football match, a strong moment is where there is a goal action. For an action film, a strong moment corresponds to fights, pursuits, etc. Said strong moments more often result in percussions on the sound band. To identify them, it is interesting to draw on segmentation and classification of the sound band in segments having a certain property or not.

In prior art, various classification systems of a sound signal exist. For example, document WO 98 27 543 describes a technique for classifying a sound signal into music or speech. Said document envisages studying the various measurable parameters of a sound signal such as the modulation energy at 4 Hz, the spectral flux, the variation of the spectral flux, the zero crossing rate, etc. Said parameters are extracted for a window of one second or another duration, in order to define the variation of the spectral flux or a frame such as the zero crossing rate. Then, using various classifiers, as for example, the classifier based on the mixture of Normal (Gaussian distribution) laws or a Nearest Neighbour classifier, an error rate in the order of 6% is obtained. The training of classifiers was carried out over thirty six minutes and the test over four minutes. Said results show that the proposed technique requires a training base of a significant size in order to achieve a recognition rate of 95%. If this is possible with forty minutes of audiovisual documents, said technique seems hardly possible for applications where the data to be classified has a large size with a high level of variability resulting from the various document sources with different levels of noise and resolution for each of said sources.

The patent U.S. Pat. No. 5,712,953 describes a system using the variation in relation to the time of the first moment of the spectrum in relation to the frequency for detecting the music signal. Said document presupposes that said variation is very low for music in contrast to other non-musical signals. Unfortunately, different types of music do not have the same structuring so that such a system has insufficient performances, as for example, for the ASR.

The European patent request 1 100 073 proposes classifying a sound signal into various categories by using eighteen parameters, as for example, the average and the variance of the signal power, the intermediate frequency power, etc. A vector quantization is produced and the Mahalanobis distance is used for the classification. It seems that using the signal power is not stable because the signals originating from different sources are always recorded with different levels of spectral power. Moreover, the use of parameters, such as the low frequency or high frequency power, for discriminating between music and speech is a serious limitation given the extreme variation of both music and speech. Finally, the choice of a suitable distance for the vectors of eighteen non-homogeneous parameters is not obvious because it concerns assigning different weights to said parameters depending on their importance.

Likewise, in the article written by ZHU LIU ET AL “AUDIO FEATURE EXTRACTION AND ANALYSIS FOR SCENE SEGMENTATION AND CLASSIFICATION”. JOURNAL OF VLSI SIGNAL PROCESSING SYSTEMS FOR SIGNAL, IMAGE AND VIDEO TECHNOLOGY, KLUWER ACADEMIC PUBLISHERS, DORDRECHT, NL, Vol. 20, no. 1/2, 1 October 1998 (1998-10-01), pages 61-78, XP000786728, ISBN: 0922-5773, a technique for classifying a sound signal into sound classes is described. Said technique envisages segmentation of the sound signal into windows of a few tens of ms and assembling into windows of 1 s. Assembling is produced by a calculation of the average of certain parameters called frequency parameters. To obtain said frequency parameters, the method consists of extracting measurements from the signal spectrum, such as the frequency centroid or the low frequency (0-630 Hz), medium frequency (630-1,720 Hz), high frequency (1,720-4,400 Hz) energy to energy ratio.

Such a method, in particular, suggests taking into account parameters extracted after a calculation on the spectrum. The implementation of such a method does not enable satisfactory recognition rates to be obtained.

The invention thus aims to resolve the aforementioned disadvantages by proposing a technique enabling the classification of a sound signal into a semantic class to be produced with a high recognition rate whilst requiring a reduced training time.

In order to achieve such an objective, the method as per the invention concerns a method for assigning at least one sound class to a sound signal, comprising the following steps:

dividing the sound signal into temporal segments having a specific duration,

extracting the frequency parameters of the sound signal in each of the temporal segments,

assembling the parameters in time windows having a specific duration greater than the duration of the temporal segments,

extracting from each time window, characteristic components,

and on the basis of the extracted characteristic components and using a classifier, identifying the sound class of each time window of the sound signal.

Another purpose of the invention is to propose an apparatus for assigning at least one sound class to a sound signal comprising:

means for dividing the sound signal into temporal segments having a specific duration,

means for extracting the frequency parameters of the sound signal in each of the temporal segments.

means for assembling the frequency parameters into time windows having a specific duration greater than the duration of the temporal segments,

means for extracting from each time window, characteristic components,

and means for identifying the sound class of the time windows of the sound signals on the basis of the characteristic components extracted and using a classifier.

Various other characteristics emerge from the aforementioned description referring to the drawings appended which show, by way of non-limitative examples, forms of embodiment of the invention.

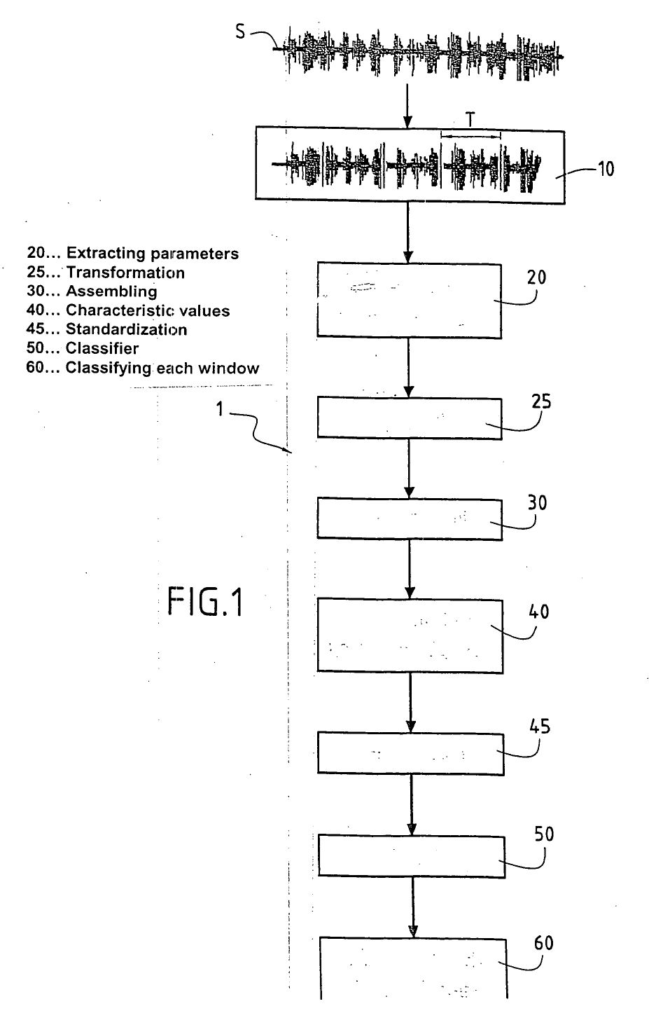

FIG. 1 is a block diagram illustrating an apparatus for implementing the method for classifying a sound signal in accordance with the invention.

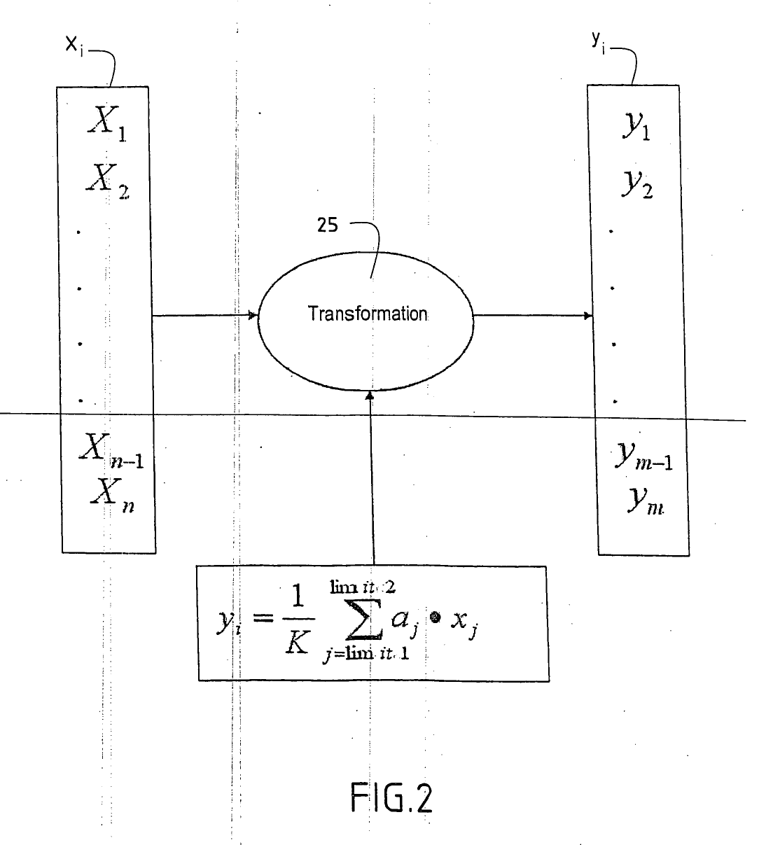

FIG. 2 is a diagram illustrating a characteristic step of the method as per the invention, that is transformation.

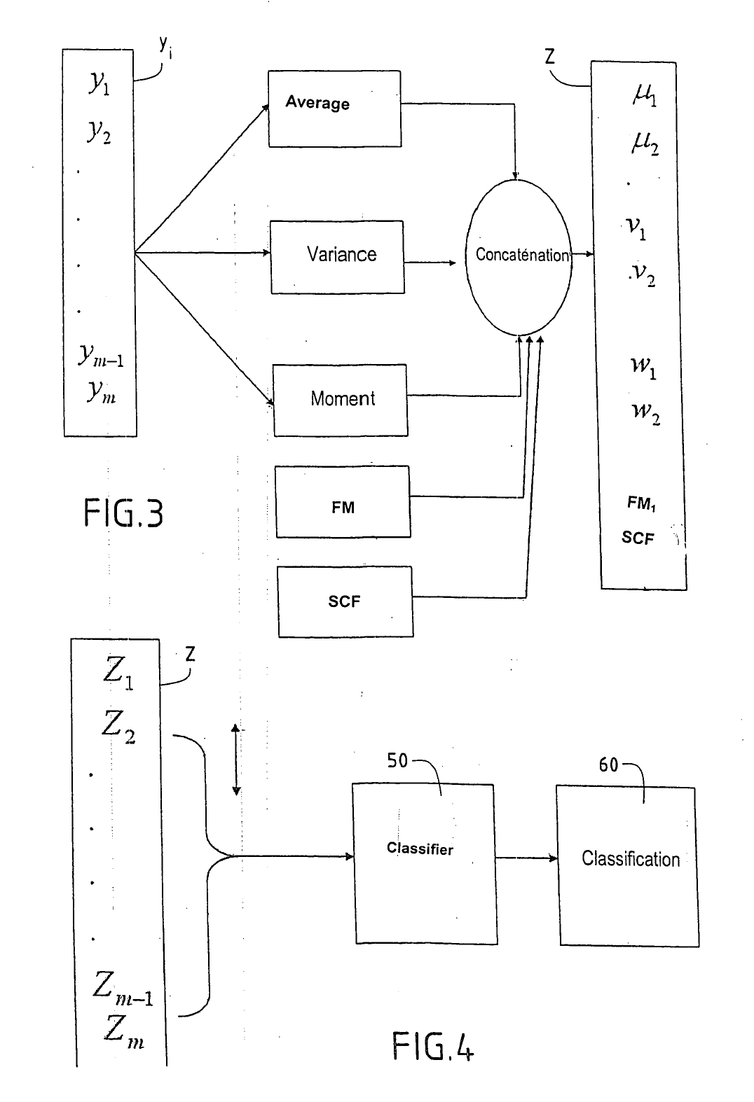

FIG. 3 is a diagram illustrating another characteristic step of the invention.

FIG. 4 illustrates a sound signal classification step as per the invention.

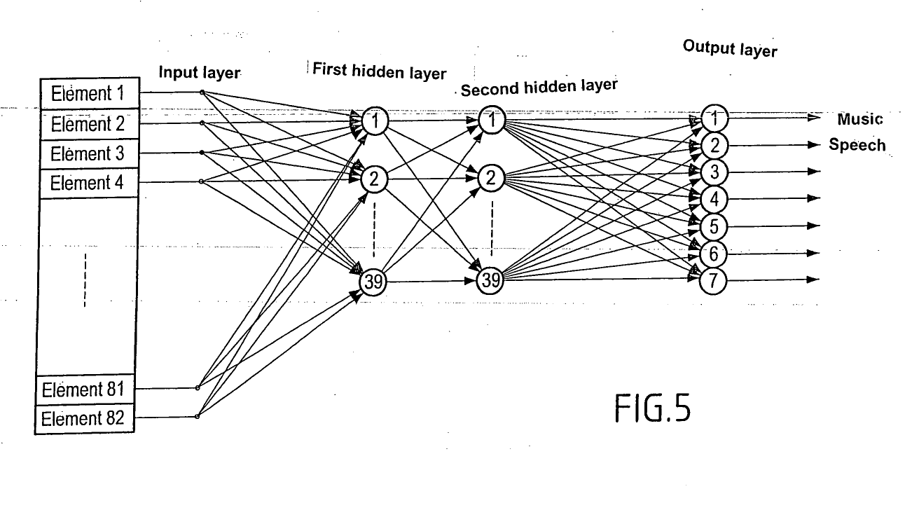

FIG. 5 is a diagram illustrating an example of neural network used within the scope of the invention.

As depicted more precisely in FIG. 1, the invention concerns an apparatus 1 enabling classification of a sound signal S of any type of sound class. In other words, the sound signal S is cut into segments which are labelled depending on their content. The labels associated to each segment, as for example, music, speech, noise, man, woman, etc. produce classification of a sound signal into semantic categories or semantic sound classes.

In accordance with the invention, the sound signal S to be classified is applied to the input of segmentation means 10 enabling the sound signal S to be divided into temporal segments T each one having a specific duration. Preferably, the temporal segments T all have the same duration preferably between ten and thirty ms. In so far as each temporal segment T has a duration of a few milliseconds, it may be considered that the signal is stable, so that transformations which change the temporal signal in the frequency domain may be applied afterwards. Different types of temporal segments may be used, as for example, simple rectangular windows, Hanning or Hamming windows.

The apparatus 1 thus comprises extraction means 20 enabling the frequency parameters of the sound signal in each of the temporal segments T to be extracted. The apparatus 1 also comprises means 30 for assembling said frequency parameters in time windows F having a specific duration greater than the duration of the temporal segments T.

As per a preferred characteristic of embodiment, the frequency parameters are assembled in time windows F with a duration greater than 0.3 seconds and preferably between 0.5 and 2 seconds. The choice of the size of the time window F is determined in order to be able to discriminate between two different windows acoustically, as for example, speech, music, man, woman, silence, etc. If the time window F is a few tens of milliseconds short for example, local acoustic changes of the volume change type, change of musical instrument and start or end of a word may be detected. If the window is large, for example a few hundredths of milliseconds for example, detectable changes will be more general types of changes, of the change of musical rhythm or speech rhythm type, for example.

The apparatus 1 also comprises extraction means 40 enabling characteristic components to be extracted from each time window F. On the basis of said characteristic components extracted and using a classifier 50, identification means 60 enable the sound class of each time window F of the sound signal S to be identified.

The following description describes a preferred variant of embodiment of a method for classifying a sound signal.

According to a preferred characteristic of embodiment, in order to cross from the time domain into the frequency domain, extraction means 20 use the Discrete Fourier Transform in the case of a sampled sound signal, noted after the DFT. The Discrete Fourier Transform provides, for a temporal series of signal amplitude values, a series of frequency spectra values. The Discrete Fourier Transform equation is as follows:

$${X}_{N} ( n ) = {\sum }_{k = 0}^{N - 1} x ( k ) {ⅇ}^{- j2π kn / N}$$

where x(k) is the signal in the time domain.

The term |X(n)| is called amplitude spectrum, it expresses the frequency division of the amplitude of the signal x(k).

The term arg[X(n)] is called phase spectrum, it expresses the frequency division of the phase of the signal x(k).

The term |X(n)|² is called energy spectrum, expressing the frequency division of the energy of the signal x(k).

The values widely used are energy spectrum values.

Consequently, for a series of time values of the amplitude of the signal x(k) for a temporal segment T, an Xᵢ series of values of the frequency spectrum in a frequency range between a minimum frequency and a maximum frequency is obtained. The collection of said frequency values or parameters is called “DFT vector” or spectral vector. Each Xᵢ vector corresponds to the spectral vector for each temporal segment T, with i going from 1 to n.

According to a preferred characteristic of embodiment, a transformation or filtering operation is performed on the frequency parameters obtained in advance via transformation means 25 interposed between the extraction means 20 and the assembling means 30. As depicted more precisely in FIG. 2, said transformation operation enables Yᵢ, a vector of transformed characteristics, to be generated from the Xᵢ spectral vector. The transformation is provided by the yᵢ formula with the variables, boundary1, boundary2, and aj which define the transformation accurately.

The transformation may be of the identity type so that the Xᵢ characteristic value does not change. According to said transformation, boundary1 and boundary2 are equal to j and the parameter aj is equal to 1. The spectral vector Xᵢ is equal to Yᵢ.

The transformation may be an average transformation of two adjacent frequencies. According to said type of transformation, the average of two adjacent frequency spectra may be obtained. For example, boundary1 is equal to j and boundary2 is equal to j+1 and aj is equal to 0.5, may be chosen.

The transformation used may be a transformation following an approximation of the Mel scale. Said transformation may be obtained by varying the boundary1 and boundary2 variables on the following values: 0, 1, 2, 3, 4, 5, 6, 8, 9, 10, 12, 15, 17, 20, 23, 27, 31, 37, 40, with

$${a}_{j} = \frac{1}{\vert boundary1 - boundary2 \vert}$$

For example, by selecting boundary1 and boundary2 as indicated above, a Y dimension vector 20 may be obtained from a gross X dimension vector 40, by using the equation described in FIG. 2.

boundary1=0→boundary2=1

boundary1=1→boundary2=2

boundary1=2→boundary2=3

boundary1=3→boundary2=4

boundary1=4→boundary2=5

boundary1=5→boundary2=6

boundary1=6→boundary2=8

boundary1=8→boundary2=9

boundary1=9→boundary2=10

boundary1=10→boundary2=12

boundary1=12→boundary2=15

boundary1=15→boundary2=17

boundary1=17→boundary2=20

boundary1=20→boundary2=23

boundary1=23→boundary2=27

boundary1=27→boundary2=31

boundary1=31→boundary2=37

boundary1=37→boundary2=40

The transformations on the Xᵢ spectral vector are more or less significant depending on the application, that is according to the sound classes to be classified. Examples of choices for said transformation will be provided in the rest of the description.

As emerging from the preceding description, the method as per the invention consists of extracting from each time window F, characteristic components, enabling a description of the sound signal to be obtained on said window having a relatively large duration. Thus, for the Yᵢ vectors of each time window F, the characteristic components computed may be the average, the variance, the moment, the frequency monitoring parameter or the silence crossing rate. The estimate of said characteristic components is performed according to the following formula:

$${\overline{w}}_{i} = ( \begin{matrix}{w}_{i1} \\ {w}_{i2} \\ ⋮ \\ {w}_{iN}\end{matrix} ) {\overline{μ}}_{i} = ( \begin{matrix}{μ}_{i1} \\ {μ}_{i2} \\ ⋮ \\ {μ}_{iN}\end{matrix} ) {\overline{v}}_{i} = ( \begin{matrix}{v}_{i1} \\ {v}_{i2} \\ ⋮ \\ {v}_{iN}\end{matrix} ) {\overline{x}}_{i} = ( \begin{matrix}{x}_{i1} \\ {x}_{i2} \\ ⋮ \\ {x}_{iN}\end{matrix} )$$

Where \tilde{μ}ᵢ is the average vector, \tilde{v}ᵢ the variance vector, \tilde{x}ᵢ being the characteristics value which is nothing more than the filtered spectral vector previously described in order to constitute the time windows F.

$${μ}_{ij} = \frac{1}{M} {\sum }_{i = 1}^{{μ}_{i}} {x}_{ij} j = 1 , ⋯ , N where j corresponds to the frequency$$

band in the spectral vector \tilde{x}, l corresponds to the time, or instant for which the vector is extracted (temporal segment T), N is the number of elements in the vector (or the number of frequency bands), Mᵢ corresponds to the number of vectors to analyse their statistics (time window F), i in μᵢⱼ corresponds to the instant of the time window F for which μᵢⱼ is computed, j corresponds to the frequency band.

$${v}_{ij} = \frac{1}{{M}_{i}} {\sum }_{i = 1}^{{M}_{i}} {( {x}_{ij} - {μ}_{ij} )}^{2} j = 1 , ⋯ , N$$

where j corresponds to the frequency band in the spectral vector \tilde{x} and in the average vector \tilde{μ}, l corresponds to the time, or the instant for which the vector \tilde{x} is extracted (temporal segment T), N is the number of elements in the vector (or the number of frequency bands), Mᵢ corresponds to the number of vectors to analyse their statistics (time window F), i in \tilde{μ}ᵢⱼ and \tilde{v}ᵢⱼ corresponds to the instant of the time window F for which \tilde{μ} and \tilde{v} is computed, j corresponds to the frequency band.
The moment which may be important for describing the behaviour of the data is computed in the following way:

$${w}_{ij} = \frac{1}{{M}_{i}} {\sum }_{i = 1}^{{M}_{i}} {( {x}_{ij} - {μ}_{ij} )}^{n} j = 1 , ⋯ , N , the indexes i , j , N , l , {M}_{i}$$

are explained for the variance, and n>2.

The method as per the invention also enables the parameter FM to be determined as characteristic components, enabling the frequencies to be monitored. Indeed, it was noted that for music, there was a certain continuity of frequencies, that is that the most important frequencies in the signal, that is those which concentrate the most energy remain the same during a certain time, whereas for speech or for noise (non-harmonic) the most significant changes in frequency occur more rapidly. From said report, it is suggested that monitoring of a plurality of frequencies is carried out at the same time according to a precision interval, for example, 200 Hz. Said choice is motivated by the fact that the most important frequencies in music change, but in a gradual way. The extraction of said frequency monitoring parameter FM is carried out in the following way. For each Discrete Fourier Transform Yᵢ vector, the identification, for example, of the five most important frequencies is carried out. If one of said frequencies does not figure in the five most important frequencies of the Discrete Fourier Transform vector, in a 100 Hz band, a cut is signalled. The number of cuts in each time window F is counted, which defines the frequency monitoring parameter FM. Said parameter FM for music segments is clearly lower than the one for speech or noise. Also, such a parameter is important for discriminating between music and speech.

According to another characteristic of the invention, the method consists of defining as characteristic component, the silence crossing rate SCR. Said parameter consists of counting in a window of fixed size, for example two seconds, the number of times where the energy reaches the silence threshold. Indeed, it must be considered that the energy of a sound signal during the expression of a word is normally high whereas it drops below the silence threshold between words. Extraction of the parameter is performed in the following way. For each 10 ms of the signal, the energy of the signal is calculated. The energy derivative is calculated in relation to the time, that is the energy of T+1 less the energy at the instant T. Then in a window of 2 seconds, the number of times where the energy derivative exceeds a certain threshold is counted.

As depicted more precisely in FIG. 3, the parameters extracted from each time window F define a characteristic value Z. Said characteristic value Z is thus the concatenation of the characteristic components defined, that is the average, variance and moment vectors, as well as the frequency monitoring FM and the silence crossing rate SCR. Depending on the application, only part or the totality of components from the characteristic value Z is used in view of a classification. For example, if the frequency range in which the spectrum is extracted is between 0 and 4,000 Hz, with frequency pitch of 100 Hz, 40 elements per spectral vector are obtained. If for the transformation of the gross Xᵢ characteristic value the identity is applied, then 40 elements for the average vector, 40 for the variance vector and 40 for the moment vector are obtained. After concatenation and addition of the SCR and FM parameters, a characteristic value Z with 122 elements is obtained. Depending on the application, the totality or only a sub-set of said characteristic values may be chosen by taking into account, for example, 40 or 80 elements.

According to a preferred embodiment of the invention, the method consists of providing a standardization operation of the characteristic components using standardization means 45 interposed between the extraction means 40 and the classifier 50. Said standardization consists, for the average vector, of searching for the component which has the maximum value and dividing the other components of the average vector by said maximum. A similar operation is performed for the variance and moment vector. For the frequency monitoring FM and the silence crossing rate SCR, said two parameters are divided by a constant fixed after experimentation in order to always obtain a value between 0.5 and 1.

After said standardization stage, a characteristic value, of which each of the components has a value between 0 and 1, is obtained. If the spectral vector has already been subject to a transformation, said standardization stage of the characteristic value may not be necessary.

As depicted more precisely in FIG. 4, the method according to the invention consists, after extraction of the parameters or constitution of the characteristic values Z, of selecting a classifier 50 enabling, using identification or classification means 60, each of the vectors to be effectively labelled as being one of the defined acoustic classes.

According to a first example of embodiment, the classifier used is a neural network, such as the multilayer perceptron with two hidden layers. FIG. 5 illustrates the architecture of a neural network comprising for example 82 input elements, 39 elements for the hidden layers and 7 output elements. Of course, it is clear that the number of said elements may be modified. The input layer elements correspond to components of the characteristic value Z. For example, if it is selected for the 80 node input layer, part of the characteristic value Z, for example the components corresponding to the average and the moment, may be used. For the hidden layer(s), the 39 elements used seem sufficient; increasing the number of neurones does not result in a notable improvement in the performances. The number of elements for the output layer corresponds to the number of classes to be classified. If two sound classes are classified, for example music and speech, the output layer comprises two nodes.

Of course, another type of classifier may be used such as the conventional K-Nearest Neighbour (KNN) classifier. In this case, knowledge of the training is simply made up of training data. Training storage consists of storing all of the training data. When a characteristic value Z is presented for classification, it is advisable to calculate the distances for all of the training data in order to select the nearest classes.

The use of a classifier enables the identification of sound classes such as speech or music, men's voices or women's voices, characteristic moment or uncharacteristic moment of a sound signal, characteristic moment or uncharacteristic moment accompanying a video signal representing, for example, a film or a match.

The following description provides an example of application of the method as per the invention for classifying a sound band into music or speech. According to said example, an input sound band is divided into a succession of speech, music, silence or other intervals. In as much as the characterisation of a silence segment is easy, experiments are conducted on a speech or music segmentation. For said application, a sub-set of the characteristic value Z was used containing 82 elements, 80 elements for the average and the variance and one for the SCR and one for the FM. The vector is subjected to an identity transformation and standardization. The size of each time window F is equal to 2s.

In order to illustrate the quality of the aforementioned characteristics and extracts of a sound segment, two classifiers were used, one based on a neural network NN, the other using the simple k-NN principle, that is “k-Nearest Neighbour”. In an aim of testing the generality of the method, NN and k-NN training was produced on 80s of music and 80s of speech extracted from the Aljazeerah network “http://www.aljazeera.net” in Arabic. Then, the two classifiers were tested on a music corpus and a speech corpus, two corpora of highly varied nature totalling 1,280s (more than 21 minutes).The result on the classification of segments of music is provided in the following table.

TABLE 1
success rate for classifying music using a NN and a k-NN

| | | | k-NN % | | NN % |
|---|---|---|---|---|---|
| | Segment | | of | | of |
| Music extracted from | length | k-NN | success | NN | success |
| Training | 80 s | 80 s | 100 | 80 s | 100 |
| Fairuz (Habbaytak | 80 s | 74 s | 92.5 | 72 s | 90 |
| bissayf) | | | | | |
| Fairuz (Habbaytak | 80 s | 80 s | 100 | 80 s | 100 |
| bissayf) | | | | | |
| Fairuz (eddach kan | 80 s | 70 s | 87.5 | 70 s | 87.5 |
| fi nass) | | | | | |
| George Michael | 80 s | 70 s | 87.5 | 80 s | 100 |
| (careless whisper) | | | | | |
| George Michael | 80 s | 76 s | 95 | 80 s | 100 |
| (careless whisper) | | | | | |
| Metallica (turn the | 80 s | 74 s | 92.5 | 78 s | 97.5 |
| page) | | | | | |
| Film “Gladiator” | 80 s | 78 s | 97.5 | 80 s | 100 |
| Total | 640 s | 602 s | 94 | 626 s | 97.8 |

It can be seen that overall the k-NN classifier provides a success rate higher than 94% whereas the NN classifier reaches a high with a 97.8% success rate. The good generalizing ability of the NN classifier can also be noted. Indeed, whilst training was produced on 80s of Lebanese music, a 100% successful classification on George Michael, a totally different type of music, and even a 97.5% classification success rate with Metallica, which is Rock music that is reputed to being difficult, was produced.

As for the experiment on the speech segments, it was carried out on varied extracts originating from CNN programmes in English, from LCI programmes in French and the film “Gladiator” whereas the training of the two classifiers was produced on 80s of speech in Arabic. The following table provides the results for the two classifiers.

TABLE 2
success rate for classifying speech using a NN and a k-NN

| | | | k-NN % | | NN % |
|---|---|---|---|---|---|
| | Segment | | of | | of |
| Speech extracted from | length | k-NN | success | NN | success |
| Training | 80 s | 80 s | 100 | 80 s | 100 |
| CNN | 80 s | 80 s | 100 | 74 s | 92.5 |
| CNN | 80 s | 72 S | 90 | 78 s | 97.5 |
| CNN | 80 s | 72 s | 90 | 76 s | 95 |
| LCI | 80 s | 58 s | 72.5 | 80 s | 100 |
| LCI | 80 s | 66 s | 82.5 | 80 s | 100 |
| LCI | 80 s | 58 s | 72.5 | 80 s | 100 |
| Film “Gladiator” | 80 s | 72 s | 90 | 72 s | 90 |
| Total | 640 s | 558 s | 87.2 | 620 s | 96.9 |

The table shows that the classifier proves to be particularly effective with LCI extracts in French because it produces a 100% correct classification. For the CNN extracts in English, it produces, all the same, a good classification rate above 92.5% and overall the NN classifier achieves a classification success rate of 97% whereas the k-NN classifier produces a good classification rate of 87%.

According to another experiment, said encouraging results for the NN classifier were selected and applied to segments mixing speech and music. For this, music training was produced on 40 seconds of the programme “the Lebanese war” broadcast by the “Aljazeerah” network, then 80 seconds of speech in Arabic extracted from the same programme. The NN classifier was tested on 30 minutes of the film “The Avengers” which was segmented and classified. The results of said experiment are provided in the following table.

TABLE 3
result for the segmentation-classification of the film

| Music error | Speech error | Segment length | Total error | % accuracy |
|---|---|---|---|---|
| 68 s | 141 s | 1,800 s | 209 s | 88.4 |

In the aim of comparing the classifier according to the invention with the work from prior art, the “Muscle Fish” tool (http://musclefish.com/speechMusic.zip) used by Virage on the same corpus was tested and the following results were obtained:

TABLE 4
result of the Muscle Fish tool for the
segmentation-classification of the film

| Music error | Speech error | Segment length | Total error | % accuracy |
|---|---|---|---|---|
| 336 s | 36 s | 1,800 s | 372 s | 79.3 |

It may be clearly noted that the NN classifier exceeds the Muscle Fish tool by 10 points in terms of accuracy.

Finally, the NN classifier was also tested on 10 minutes of “LCI” programmes, comprising “I'édito”, “I'invité” and “la vie des medias” and the following results were obtained:

TABLE 5
result for the segmentation-classification of the LCI programmes

| Music error | Speech error | Segment length | Total error | % accuracy |
|---|---|---|---|---|
| 12 s | 2 s | 600 s | 14 s | 97.7 |

Whereas the “Muscle Fish” tool provided the following results:

TABLE 6
result for the segmentation-classification of the LCI programmes
with the Muscle Fish tool

| Music error | Speech error | Segment length | Total error | % accuracy |
|---|---|---|---|---|
| 2 s | 18 s | 600 s | 20 s | 96.7 |

The summary results by the NN classifier are as follows:

TABLE 7
result for the segmentation-classification on the various videos

| | | | % | % |
|---|---|---|---|---|
| Training data | Test data | Total error | training/test | accuracy |
| 120 s | 3,000 s | 227 s | 4 s | 92.4 |

It can be seen that for an accuracy rate higher than 92% over 50 minutes in said experiment, the NN classifier only generates a T/T rate (training duration/test duration) of 4%, which is very encouraging in relation to the T/T rate of 300% for the [Will 99] system (Gethin Williams, Daniel Ellis, Speech/music discrimination based on posterior probability features, Eurospeech 1999) based on the HMM (Hidden Markov Model) posterior probability parameters and by using the GMMs.

A second example of experiment was produced in order to classify a sound signal in men's voices and women's voices. According to said experiment, speech segments are cut into pieces labelled masculine voice or feminine voice. To this effect, the characteristic value does not consist of the silence crossing rate and the frequency monitoring. The weight of said two parameters is thus brought to 0. The size of the time window F was fixed at 1 second.

Experiments were produced on data from telephone calls from the “Linguistic Data Consortium” LCD (http://www.Idc.upenn.edu) Switchboard. It was selected for training and for telephone call tests between speakers of the same type, that is man-man and woman-woman conversations. The training was carried out on 300s of speech extracted from 4 man-man telephone calls and 300s of speech extracted from 4 woman-woman telephone calls. The method as per the invention was tested on 6,000s (100 minutes) thus 3,000 extracts of 10 man-man calls which are different from the calls used for the training, and 3,000s extracted from 10 woman-woman calls, also different from the calls used for the training. The table below summarizes the results obtained.

| | | Seg- | | Speech time | |
|---|---|---|---|---|---|
| Detection | Detection | ment | Segment | for the | |
| rate | rate | length | length | Training/Total | % |
| man | woman | man | woman | test time | accuracy |
| 85% | 90% | 3,000 s | 3,000 s | 10% | 87.5% |

It can be seen that the overall detection rate is 87.5% with a sample of speech for the training which is only 10% of the speeches tested. It can also be noted that the method as per the invention produces better feminine (90%) speech detection than masculine (85%). Said results may still be considerably improved if the majority vote principle is applied to the homogeneous segments following blind segmentation and if long silences are eliminated, which occur fairly often in telephone conversations and which lead to a woman labelling by the technique as per the invention.

Another experiment aims to classify a sound signal into an important moment or not in a sports match. The detection of key moments in a sports match, for example that of football, in a direct audiovisual retransmission context is very important for enabling automatic generation of audiovisual summaries which may be a compilation of images, key moments thus detected. Within the context of a football match, a key moment is a moment where a goal action, penalty, etc. occurs. In the context of a basketball match, a key moment can be defined by a moment where an action placing the ball into the basket occurs. In the context of a rugby match, a key moment can be defined by a moment where a try action occurs for example. Said notion of key moment may of course be applied to any sports matches.

The detection of key moments in a sports audiovisual sequence reverts to a problem of classifying the sound band, the terrain, the assistance and the commentators accompanying the progress of the match. Indeed, during important moments in a sports match, as for example, that of football, they result in a tension in the tone of speech of the commentator and the intensification of the noise from spectators. Before said experiment, the characteristic value used is the one used for classifying music/speech by only taking out the two SCR and FM parameters. The transformation used on the gross characteristic values is the one following the Mel scale, whereas the standardization stage is not applied to the characteristic value. The size of the time window F is 2 seconds.

Three football matches from the UEFA cup were selected for the experiments. For the training, 20s of key moments and 20s of non-key moments from the first match were selected. There are, therefore, two sound classes: key moment or non-key moment.

After the training, classification on the three matches was carried out. The results were evaluated in terms of number of goals detected, and in terms of time classified as important.

| | Number of | Important time | Goals | |
|---|---|---|---|---|
| | goals | detected | detected | % accuracy |
| Match 1 | 3 | 90 | 3 | 100 |
| Match 2 | 0 | 40 | 0 | NA |
| Match 3 | 4 | 80 | 4 | 100 |

The table shows that all of the goal moments were detected. In addition, for a 90-minute football match, a 90-second summary at most including all of the goal moments is generated.

Of course, classifying in important or non-important moments may be generalised to the sound classification of any audiovisual documents, such as an action film or a pornographic film.

The method as per the invention also enables, by any suitable means, a label to be assigned for each time window assigned to a class and labels to be searched for, such as a sound signal for example, recorded in a database.

The invention is not limited to the examples described and represented because various modifications may be made without deviating from its scope.

1. A method for assigning at least one sound class to a sound signal, characterized in that it comprises the following steps:
dividing the sound signal into temporal segments (T) having a specific duration,
extracting the frequency parameters of the sound signal in each of the temporal segments (T), by determining a series of values of the frequency spectrum in a frequency range between a minimum frequency and a maximum frequency,
assembling the parameters in time windows (F) having a specific duration greater than the duration of the temporal segments (T),
extracting from each time window (F), characteristic components,
and on the basis of the extracted characteristic components and using a classifier, identifying the sound class of the time windows (F) of the sound signal.

2. A method as per claim 1, characterized in that it consists of extracting the sound signal into temporal segments (T), the duration of which is between 10 and 30 ms.

3. A method as per claim 1, characterized in that it consists of extracting the frequency parameters using the Discrete Fourier Transform.

4. A method as per claim 3, characterized in that is consists of providing an operation for transforming or filtering frequency parameters.

5. A method as per claim 4, characterized in that it consists of producing a transformation of the identity type, average of two adjacent frequencies, or as per the Mel scale.

6. A method as per claim 4, characterized in that it consists of assembling the frequency parameters in the time windows of a duration greater than 0.3 seconds and preferably between 0.5 and 2 seconds.

7. A method as per claim 1, characterized in that it consists of extracting from each time window, characteristic components such as the average, the variance, the moment, the frequency monitoring parameter or the silence crossing rate.

8. A method as per claim 7, characterized in that it consists of using one or more input characteristic components of the classifier.

9. A method as per claim 7, characterized in that it consists of providing a standardization operation of the characteristic components.

10. A method as per claim 9, characterized in that the standardization operation comprises:
for the average, the variance or the moment, searching for the component having the maximum value and dividing the other components by said maximum value,
for the frequency monitoring or the silence crossing rate, dividing each of said characteristic components by a constant fixed after experimentation in order to obtain a value between 0.5 and 1.

11. A method as per claim 1, characterized in that it consists of using as a classifier, a neural network or the K-Nearest Neighbour.

12. A method as per claim 11, characterized in that it consists of producing a sound signal training phase for the classifier.

13. A method as per claim 1, characterized in that it consists of, using a classifier, identifying sound classes such as speech or music, men's voices or women's voices, characteristic moment or uncharacteristic moment of a sound signal, characteristic moment or uncharacteristic moment accompanying a video signal representing, for example, a film or a match.

14. A method as per claim 13, characterized in that it consists of classifying the sound signal into music or into speech by using the average, variance, frequency monitoring and silence crossing rate parameters, followed by a standardization of the parameters while the time window is equal to 2 s.

15. A method as per claim 13, characterized in that it consist of classifying the signal of a important moment or unimportant moment match by using the average and variance parameters, with a transformation as per the Mel scale without applying standardization of the characteristic components.

16. A method as per claim 13, characterized in that it consists of identifying the strong moments in a sound signal of a match.

17. A method as per claim 16, characterized in that it consists of using the identification of strong moments to create a match summary.

18. A method as per claim 13, characterized in that it consists of identifying and monitoring the speech in a sound signal.

19. A method as per claim 18, characterized in that it consists of identifying and monitoring the speech of a man and/or woman for the speech part of the sound signal.

20. A method as per claim 13, characterized in that it consists of identifying and monitoring the music in a sound signal.

21. A method as per claim 13, characterized in that it consists of determining if the sound signal contains speech or music.

22. A method as per claim 13, characterized in that it consists of assigning a label for each time window assigned to a class.

23. A method as per claim 22, characterized in that it consists of searching for labels for a sound signal.

24. An apparatus for assigning at least one sound class to a sound signal, characterized in that it comprises:
means (10) for dividing the sound signal (S) into temporal segments (T) having a specific duration,
means (20) for extracting frequency parameters of the sound signal into each of the temporal segments (T),
means (30) for assembling the frequency parameters into time windows (F) having a specific duration greater than the duration of the temporal segments,
means (40) for extracting from each time window (F), characteristic components,
and means (60) for identifying the sound class of the time windows (F) of the sound signal on the basis of the characteristic components extracted and using a classifier.

25. An apparatus as per claim 24, characterized in that the means (20) for extracting the frequency parameters use the Discrete Fourier Transform.

26. An apparatus as per claim 24 characterized in that it comprises means (25) for providing an operation for transforming or filtering frequency parameters.

27. An apparatus as per claim 24, characterized in that it comprises means (30) for assembling the frequency parameters in the time windows (F) of a duration greater than 0.3 seconds and preferably between 0.5 and 2 seconds.

28. An apparatus as per claim 24, characterized in that it comprises as means (40) for extracting from each time window, characteristic components, means for extracting the average, the variance, the moment and the frequency monitoring parameter or the silence crossing rate.

29. An apparatus as per claim 28, characterized in that it comprises characteristic component standardization means (45).

30. An apparatus as per claim 24, characterized in that it comprises as classifier, a neural network or the K-Nearest Neighbour.

31. An apparatus as per claim 24, characterized in that it comprises means (60) for identifying the sound classes such as speech or music, men's voices or women's voices, characteristic or uncharacteristic moment of a sound signal, characteristic or uncharacteristic moment accompanying a video signal representing, for example, a film or a match.

32. An apparatus as per claim 24, characterized in that it comprises means for assigning a label for each time window assigned to a class.

33. An apparatus as per claim 32, characterized in that it comprises means for searching for labels for a sound signal recorded in a database.
